(19) United States
(12) Patent Application Publication
(10) Pub. No.: US 2022/0121062 A1
(43) Pub. Date: Apr. 21, 2022

(54) LIQUID CRYSTAL DISPLAY DEVICE AND MANUFACTURING METHOD THEREOF

(71) Applicant: HUIZHOU CHINA STAR OPTOELECTRONICS TECHNOLOGY CO., LTD., Huizhou, Guangdong (CN)

(72) Inventors: Xin ZHANG, Huizhou, Guangdong (CN); Zanjia SU, Huizhou, Guangdong (CN); Chingyuan CHENG, Huizhou, Guangdong (CN); Dongchen HUANG, Huizhou, Guangdong (CN)

(21) Appl. No.: 16/768,711

(22) PCT Filed: Apr. 1, 2020
(86) PCT No.: PCT/CN2020/082717

§ 371 Date: Jun. 1, 2020

(30) Foreign Application Priority Data
Mar. 13, 2020 (CN) 202010174276.7

(51) Int. Cl. G02F 1/1335; G02F 1/1333; G06F 3/041

(52) U.S. Cl. CPC G02F 1/133531; G02F 1/133514; G06F 3/0412; G02F 1/133331; G02F 1/13338

(57) ABSTRACT

The present invention provides a liquid crystal display device and a manufacturing method thereof. The liquid crystal display device includes a backlight module, a liquid crystal display panel, a middle polarizer, an upper polarizer, and a glass cover plate laminated in sequence from bottom to top. Wherein, the middle polarizer is disposed parallel to a polarizing axis of the upper polarizer in arrangement, which is used to select ambient light passing through the middle polarizer and the polarizing axis of the upper polarizer and being parallel to the polarizing axis, and to reflect remaining light, thereby reducing intensity of reflected ambient light.

### FIELD OF INVENTION

The present disclosure relates to the field of display technology, and more particularly, to a liquid crystal display device and a manufacturing method thereof.

### BACKGROUND OF INVENTION

With wide application of large-size liquid crystal display devices, conference all-in-one machines and electronic whiteboards used in commercial display devices have a wide market demand. For the conference all-in-one machines and electronic whiteboards, the liquid crystal display devices have good visibility at wide viewing-angle to achieve meeting interaction in a meeting environment or an educational environment under ambient light. However, traditional television display modules cause the liquid crystal display under ambient light to have poor visibility at wide viewing-angle, due to greater surface reflectivity of the liquid crystal displays. From a perspective of specular reflection, display effect observed by users will be whitened, resulting in poor user experience.

As shown in FIG. 1, FIG. 1 is a schematic structural diagram of a traditional touch control liquid crystal display device. A touch control liquid crystal display device 90 includes a backlight module 91, a liquid crystal display panel 92, a touch control layer 93, and a glass cover plate 94 laminated in sequence from bottom to top. In traditional touch control display conference machines, when ambient light irradiates the touch control display device, specular reflection and diffuse reflection mainly occur. At a same time, a surface has a high reflectivity, so a phenomenon of whitening will occur when viewed at wide viewing-angle. Due to mixed light phenomenon between reflected ambient light and light of the liquid crystal display panel, light intensity of the reflected light is close to or even exceeds light intensity of the liquid crystal display panel. Therefore, visibility of the touch control liquid crystal display device at wide viewing-angle is poor.

### SUMMARY OF INVENTION

An embodiment of the present disclosure provides a liquid crystal display device and a manufacturing method thereof, to solve phenomenon that light intensity of reflected ambient light in current liquid crystal display devices is close to or even exceeds light intensity of light emitted by the liquid crystal display panel, resulting in phenomenon of whitening, which causes a technical problem of poor visibility of the liquid crystal display devices at wide viewing-angle.

The embodiment of the present disclosure provides a liquid crystal display device comprising a backlight module, a liquid crystal display panel, a middle polarizer, an upper polarizer, and a glass cover plate laminated in sequence from bottom to top. An upper surface of the backlight module is a light-emitting surface and is used to provide a light source. The liquid crystal display panel is disposed on the backlight module. The middle polarizer is disposed on the liquid crystal display panel. The upper polarizer is disposed on the middle polarizer. The glass cover plate is disposed on the upper polarizer. Wherein, the middle polarizer is disposed parallel to a polarizing axis of the upper polarizer in arrangement, which is used to select ambient light passing through the middle polarizer and the polarizing axis of the upper polarizer and being parallel to the polarizing axis, and to reflect remaining light, thereby reducing intensity of reflected ambient light.

Furthermore, the middle polarizer is a wide viewing-angle polarizer.

Furthermore, the liquid crystal display device further comprises a touch control layer disposed between the liquid crystal display panel and the middle polarizer.

Furthermore, the liquid crystal display device further comprises a lower polarizer disposed between the backlight module and the liquid crystal display panel, and the lower polarizer is disposed perpendicular to the polarizing axis of the upper polarizer in arrangement.

Furthermore, the liquid crystal display panel comprises an array substrate, a color film substrate disposed on the array substrate, and a liquid crystal layer disposed between the array substrate and the color film substrate.

Furthermore, the liquid crystal display device further comprises an air layer disposed between the middle polarizer and the upper polarizer.

Furthermore, the upper polarizer is attached on a lower surface of the glass cover plate.

The present disclosure further provides a manufacturing method of a liquid crystal display device comprising following steps:

Forming a backlight module. An upper surface of the backlight module is a light-emitting surface and is used to provide a light source.

Forming a liquid crystal display panel on the backlight module.

Forming a middle polarizer on the liquid crystal display panel.

Forming an upper polarizer on the middle polarizer. The middle polarizer is disposed parallel to a polarizing axis of the upper polarizer in arrangement, which is used to select ambient light passing through the middle polarizer and the polarizing axis of the upper polarizer and being parallel to the polarizing axis, and to reflect remaining light, thereby reducing an intensity of reflected ambient light.

Forming a glass cover plate on the upper polarizer.

Furthermore, a step of forming a touch control layer on the liquid crystal display panel is between the step of forming the liquid crystal display panel and the step of forming the middle polarizer.

Furthermore, the step of forming the upper polarizer and the glass cover plate on the middle polarizer specifically comprises attaching the upper polarizer on a lower surface of the glass cover plate, attaching a side of the upper polarizer on the middle polarizer, and forming an air layer between the middle polarizer and the upper polarizer.

A beneficial effect of the present disclosure is to provide a liquid crystal display device and a manufacturing method thereof. The upper polarizer and the middle polarizer parallel to the polarizing axis are disposed on the lower surface of the glass cover plate, which mainly reduces ambient light entering the liquid crystal display device from a side of the glass cover plate, and reduce the reflected ambient light by half, thereby reducing the intensity of the reflected ambient light, preventing the phenomenon of whitening, and improving visibility of the liquid crystal display device. Meanwhile, the middle polarizer adopts a wide viewing-angle polarizer, which can enhance light output of the liquid crystal display panel at wide viewing-angle and enhance visibility at wide viewing-angle.

### DESCRIPTION OF DRAWINGS

FIG. 1 is a schematic structural diagram of a traditional touch control liquid crystal display device.

FIG. 2 is a schematic structural diagram of a liquid crystal display device provided by an embodiment 1 of the present disclosure.

FIG. 3 is a schematic structural diagram of the liquid crystal display device provided by an embodiment 2 of the present disclosure.

FIG. 4 is a flowchart of a manufacturing method of the liquid crystal display device in the embodiment of the present disclosure.

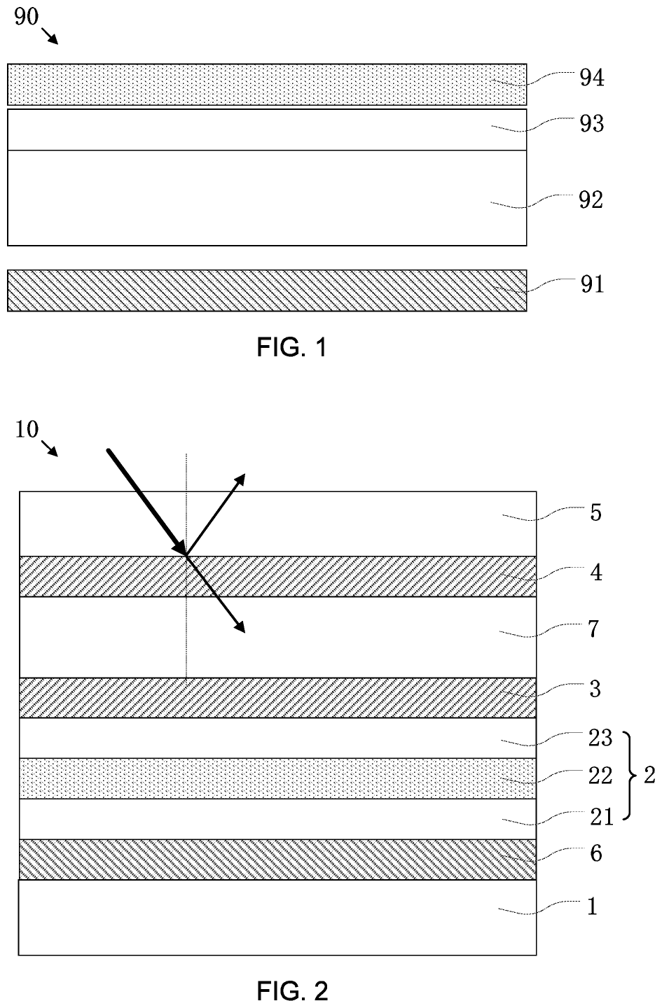

Figure numerals: backlight module 1, liquid crystal display panel 2, middle polarizer 3, upper polarizer 4, glass cover plate 5, lower polarizer 6, air layer 7, touch control layer 8, liquid crystal display device 10, array substrate 21, liquid crystal layer 22, color film substrate 23.

### DETAILED DESCRIPTION OF PREFERRED EMBODIMENTS

The technical solutions in the embodiments of the present disclosure will be clearly and completely described below in conjunction with accompanying drawings in the embodiments of the present disclosure. Obviously, the embodiments described are merely a part of the present disclosure, rather than all the embodiments. All other embodiments obtained by the person having ordinary skill in the art based on embodiments of the disclosure, without making creative efforts, are within the scope of the present disclosure.

In the present disclosure, the terms “mounting”, “connected”, “fixed” and the like should be broadly understood unless expressly stated or limited otherwise. For example, it may be fixed connected, removably connected, or integrated; it may be mechanically connected, or an electrically connected; it may be directly connected, or indirectly connected through an intermediary; it may be a connection between two elements or an interaction between two elements. For those skilled in the art, the specific meanings of the above terms in the present disclosure may be understood based on specific situations.

In the present disclosure, unless explicitly stated and defined otherwise, the first feature may be “above” or “below” the second feature and may include direct contact between the first and second features. It may also include that the first and second features are not in direct contact but are contacted by another feature between them. Moreover, the first feature is “above” the second feature, including the first feature directly above and obliquely above the second feature, or merely indicates that the first feature is higher in level than the second feature. The first feature is “below” the second feature, including the first feature is directly below and obliquely below the second feature, or only indicates that the first feature is less horizontal than the second feature.

The following disclosure provides many different embodiments or examples for achieving different structures of the present disclosure. To simplify the present disclosure, components and settings of specific examples are described below. They are only examples and are not intended to limit the present disclosure.

### Embodiment 1

As shown in FIG. 2, Embodiment 1 of the present disclosure provides a liquid crystal display device 10 comprising a backlight module 1, a liquid crystal display panel 2, a middle polarizer 3, an upper polarizer 4, and a glass cover plate 5 laminated in sequence from bottom to top. An upper surface of the backlight module 1 is a light-emitting surface and is used to provide a light source. The liquid crystal display panel 2 is disposed on the backlight module 1. The middle polarizer 3 is disposed on the liquid crystal display panel 2. The upper polarizer 4 is disposed on the middle polarizer 3. The glass cover plate 5 is disposed on the upper polarizer 4. Wherein, the middle polarizer 3 is disposed parallel to a polarizing axis of the upper polarizer 4 in arrangement, which is used to select ambient light passing through the middle polarizer 3 and the polarizing axis of the upper polarizer 4 and being parallel to the polarizing axis, and to reflect remaining light, thereby reducing intensity of reflected ambient light.

A principle is shown in FIG. 2, the upper polarizer 4 and the middle polarizer 3 parallel to the polarizing axis are disposed on a lower surface of the glass cover plate 5. When external ambient light (indicated by solid arrows in the figure) enters the liquid crystal display device 10 from a side of the glass cover plate 5, the ambient light is circularly polarized light. When passing through the upper polarizer 4, only light with an amplitude parallel to the polarizing axis of the upper polarizer 4 can pass through, and the remaining ambient light is reflected, and the reflected ambient light is 50% of the original. Compared with reflecting ambient light of current liquid crystal display devices at 100%, the present embodiment can reduce the reflected ambient light by half, thereby reducing intensity of the reflected ambient light, preventing a phenomenon of whitening, and improving visibility of liquid crystal display device 10. Meanwhile, the middle polarizer 3 adopts a wide viewing-angle polarizer, which can enhance light output of the liquid crystal display panel 2 at wide viewing-angle and enhance visibility at wide viewing-angle.

In the present embodiment, the middle polarizer 3 is a wide viewing-angle polarizer, which is used to enhance visibility at wide viewing-angle.

In the present embodiment, the liquid crystal display device 10 further comprises a lower polarizer 6, the lower polarizer 6 is disposed between the backlight module 1 and the liquid crystal display panel 2, and the lower polarizer 6 is disposed perpendicular to the polarizing axis of the upper polarizer 4 in arrangement, that is, the middle polarizer 3 is arranged perpendicular to the polarization axis of the upper polarizer 4.

In the present embodiment, the liquid crystal display panel 2 comprises an array substrate 21, a color film substrate 23 disposed on the array substrate 21, and a liquid crystal layer 22 disposed between the array substrate 21 and the color film substrate 23.

Light emitted by the backlight module 1 is circularly polarized light. First, the light passes through the lower polarizer 6 and select light with amplitude parallel to the polarizing axis of the lower polarizer 6, and an amplitude direction of the light is rotated 90 degrees when passing through the liquid crystal layer 22 of the liquid crystal display panel 2. Since the polarizing axis of the middle polarizer 3 is disposed perpendicular to the polarizing axis of the upper polarizer 4 in arrangement, the light can just pass through the middle polarizer 3 and propagate outward. Since the middle polarizer 3 is arranged parallel to the polarizing axis of the upper polarizer 4, the light can also pass through the upper polarizer 4 and propagate outward to light up screens.

In the present embodiment, the liquid crystal display device 10 further comprises an air layer 7, and the air layer 7 is disposed between the middle polarizer 3 and the upper polarizer 4. The air layer 7 is formed when the glass cover plate 5 is attached to the liquid crystal display panel 2.

In the present embodiment, the upper polarizer 4 is attached on a lower surface of the glass cover plate 5.

### Embodiment 2

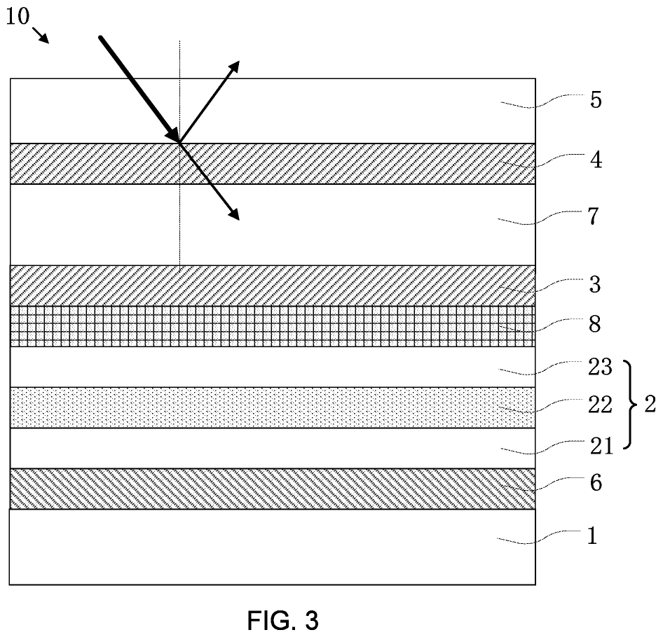

As shown in FIG. 3, Embodiment 2 comprises all the technical features of Embodiment 1, and a difference is that the liquid crystal display device 10 in Embodiment 2 further comprises a touch control layer 8, and the touch control layer 8 is disposed between the liquid crystal display panel 2 and the middle polarizer 3.

The touch control layer 8 is formed to touch a surface of screens, thereby achieving touch control and operation, which is conducive to improving user experience.

The principle is the same as in Embodiment 1. The upper polarizer 4 and the middle polarizer 3 parallel to the polarizing axis are disposed on a lower surface of the glass cover plate 5. When external ambient light (indicated by solid arrows in the figure) enters the liquid crystal display device 10 from a side of the glass cover plate 5, the ambient light is circularly polarized light. When passing through the upper polarizer 4, only light with an amplitude parallel to the polarizing axis of the upper polarizer 4 can pass through, and the remaining ambient light is reflected, and the reflected ambient light is 50% of the original. Compared with reflecting ambient light of current liquid crystal display devices at 100%, the present embodiment can reduce the reflected ambient light by half, thereby reducing intensity of the reflected ambient light, preventing the phenomenon of whitening, and improving visibility of liquid crystal display device 10. Meanwhile, the middle polarizer 3 adopts a wide viewing-angle polarizer, which can enhance light output of the liquid crystal display panel 2 at wide viewing-angle and enhance visibility at wide viewing-angle.

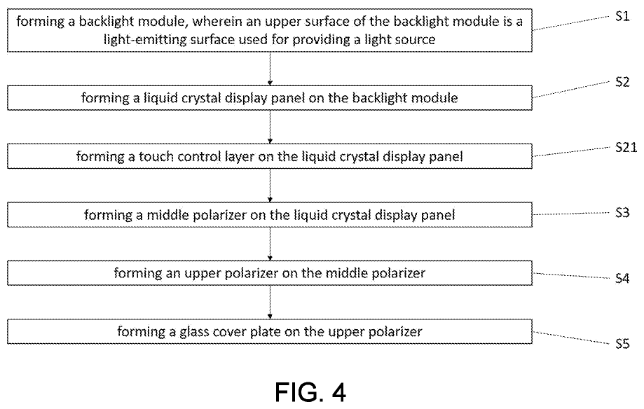

As shown in FIG. 4, the present disclosure further provides a manufacturing method of a liquid crystal display device 10 comprising following steps:

Step S1: forming a backlight module 1. An upper surface of the backlight module 1 is a light-emitting surface and is used to provide a light source.

Step S2: forming a liquid crystal display panel 2 on the backlight module 1.

Step S3: forming a middle polarizer 3 on the liquid crystal display panel 2.

Step S4: forming an upper polarizer 4 on the middle polarizer 3. The middle polarizer 3 is disposed parallel to a polarizing axis of the upper polarizer 4 in arrangement, which is used to select ambient light passing through the middle polarizer 3 and the polarizing axis of the upper polarizer 4 and being parallel to the polarizing axis, and to reflect remaining light, thereby reducing an intensity of reflected ambient light.

Step S5: forming a glass cover plate 5 on the upper polarizer 4.

The principle is shown in FIG. 2, the upper polarizer 4 and the middle polarizer 3 parallel to the polarizing axis are disposed on a lower surface of the glass cover plate 5. When external ambient light enters the liquid crystal display device 10 from a side of the glass cover plate 5, the ambient light is circularly polarized light. When passing through the upper polarizer 4, only light with an amplitude parallel to the polarizing axis of the upper polarizer 4 can pass through, and the remaining ambient light is reflected, and the reflected ambient light is 50% of the original. Compared with reflecting ambient light of current liquid crystal display devices at 100%, the present embodiment can reduce the reflected ambient light by half, thereby reducing intensity of the reflected ambient light, preventing the phenomenon of whitening, and improving visibility of liquid crystal display device 10. Meanwhile, the middle polarizer 3 adopts a wide viewing-angle polarizer, which can enhance light output of the liquid crystal display panel 2 at wide viewing-angle and enhance visibility at wide viewing-angle.

In the present embodiment, a step S21 of forming a touch control layer 8 on the liquid crystal display panel 2 is between the step of forming the liquid crystal display panel 2 and the step of forming the middle polarizer 3. Meanwhile, the step S3 of forming the middle polarizer 3 is specifically: forming the middle polarizer 3 on the touch control layer 8.

In the present embodiment, the step of forming the upper polarizer 4 and the glass cover plate 5 on the middle polarizer 3 specifically comprises: attaching the upper polarizer 4 on a lower surface of the glass cover plate 5, attaching a side of the upper polarizer 4 on the middle polarizer 3, and forming an air layer 7 between the middle polarizer 3 and the upper polarizer 4.

The beneficial effect of the present disclosure is to provide the liquid crystal display device and the manufacturing method thereof. The upper polarizer and the middle polarizer parallel to the polarizing axis are disposed on the lower surface of the glass cover plate, which mainly reduces ambient light entering the liquid crystal display device from the side of the glass cover plate, and reduce the reflected ambient light by half, thereby reducing the intensity of the reflected ambient light, preventing the phenomenon of whitening, and improving visibility of the liquid crystal display device. Meanwhile, the middle polarizer adopts a wide viewing-angle polarizer, which can enhance light output of the liquid crystal display panel at wide viewing-angle and enhance visibility at wide viewing-angles.

In the above embodiments, the description of each embodiment has its own emphasis. For a part that is not detailed in an embodiment, you can refer to the related descriptions of other embodiments.

The liquid crystal display device and the manufacturing method thereof provided by the embodiments of the present disclosure are described in detail above. The present disclosure uses specific examples to describe principles and embodiments of the present disclosure. The descriptions of the above embodiments are only used to help understand technical solutions of the present disclosure and core ideas thereof. Moreover, those of ordinary skill in the art should understand that the technical solutions described in the aforesaid embodiments can still be modified, or have some technical features equivalently replaced. However, these modifications or replacements do not depart from a scope of the technical solutions of the embodiments of the present disclosure.

What is claimed is:

1. A liquid crystal display device, comprising:
a backlight module, wherein an upper surface of the backlight module is a light-emitting surface used for providing a light source;
a liquid crystal display panel disposed on the backlight module;
a middle polarizer disposed on the liquid crystal display panel;
an upper polarizer disposed on the middle polarizer; and
a glass cover plate disposed on the upper polarizer;
wherein the middle polarizer is disposed parallel to a polarizing axis of the upper polarizer in arrangement, which is used to select ambient light passing through the middle polarizer and the polarizing axis of the upper polarizer and being parallel to the polarizing axis, and to reflect remaining light, thereby reducing an intensity of reflected ambient light.

2. The liquid crystal display device as claimed in claim 1, wherein the middle polarizer is a wide viewing-angle polarizer.

3. The liquid crystal display device as claimed in claim 1, wherein the liquid crystal display device comprises a touch control layer disposed between the liquid crystal display panel and the middle polarizer.

4. The liquid crystal display device as claimed in claim 1, wherein the liquid crystal display device comprises a lower polarizer disposed between the backlight module and the liquid crystal display panel, and the lower polarizer is disposed perpendicular to the polarizing axis of the upper polarizer in arrangement.

5. The liquid crystal display device as claimed in claim 1, wherein the liquid crystal display panel comprises:
an array substrate;
a color film substrate disposed on the array substrate; and
a liquid crystal layer disposed between the array substrate and the color film substrate.

6. The liquid crystal display device as claimed in claim 1, wherein the liquid crystal display device comprises an air layer disposed between the middle polarizer and the upper polarizer.

7. The liquid crystal display device as claimed in claim 6, wherein the upper polarizer is attached on a lower surface of the glass cover plate.

8. A manufacturing method of a liquid crystal display device, comprising following steps:
forming a backlight module, wherein an upper surface of the backlight module is a light-emitting surface used for providing a light source;
forming a liquid crystal display panel on the backlight module;
forming a middle polarizer on the liquid crystal display panel; and
forming an upper polarizer on the middle polarizer;
wherein the middle polarizer is disposed parallel to a polarizing axis of the upper polarizer in arrangement, which is used to select ambient light passing through the middle polarizer and the polarizing axis of the upper polarizer and being parallel to the polarizing axis, and to reflect remaining light, thereby reducing an intensity of reflected ambient light; and
forming a glass cover plate on the upper polarizer.

9. The manufacturing method of the liquid crystal display device as claimed in claim 8, wherein a step of forming a touch control layer on the liquid crystal display panel is between the step of forming the liquid crystal display panel and the step of forming the middle polarizer.

10. The manufacturing method of the liquid crystal display device as claimed in claim 8, wherein the step of forming the upper polarizer and the glass cover plate on the middle polarizer specifically comprises:
attaching the upper polarizer on a lower surface of the glass cover plate, attaching a side of the upper polarizer on the middle polarizer, and forming an air layer between the middle polarizer and the upper polarizer.
